(19) United States
(12) Patent Application Publication
(10) Pub. No.: US 2008/0096789 A1
(43) Pub. Date: Apr. 24, 2008

(54) Laundry Treatment Composition

(76) Inventor: Stephen Norman Batchelor, Wirral (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 11/663,575

(22) PCT Filed: Aug. 8, 2005
(86) PCT No.: PCT/EP05/08629

§ 371 Date: Mar. 23, 2007

(30) Foreign Application Priority Data
Sep. 23, 2004 (GB) 0421145.4

(51) Int. Cl. C11D 3/42

(52) U.S. Cl. 510/513

(57) ABSTRACT

The present invention provides a treatment composition comprising a hydrophobic dye and a second dye, selected from hydrolysed reactive dyes, acid dyes and direct dyes; and a surfactant.

### TECHNICAL FIELD

The present invention relates to laundry treatment compositions that comprise a dye.

### BACKGROUND OF THE INVENTION

Garments comprising polyester fibres are ubiquitous. Many garments are white but over the lifetime of these garments the whiteness is dulled reducing the aesthetic value of the garment. There is a need to maintain the white appearance of such garments such that the aesthetic value is retained as long as possible. Such maintenance need also take into account mixed fibre garments such that any treatment is not overly selective to one type of fibre over another.

Bleach, fluorescers and shading agents are used in modern wash processes to maintain whiteness. The fluorescers and shading agents that are currently available, do not deposit on polyester fibres of garments to a significant degree. All fibres may be subjected to a bleaching process but over time such treatment can lead to the garment taking a yellow hue.

There is a need to provide technology that maintains and enhances the white appearance of polyester-cotton comprising garments.

### SUMMARY OF THE INVENTION

Hydrophobic dyes have been found to be substantive to polyester fibres under normal domestic wash conditions. At low levels this provides a shading whiteness benefit.

In one aspect the present invention provides a laundry treatment composition comprising: between 0.0001 to 0.1 wt % of a hydrophobic dye for shading polyester; between 0.0001 to 0.1 wt % of one or more other dyes selected from cotton substantive shading dyes of the group consisting of: hydrolysed reactive dye; acid dye; and direct dye; and, between 2 to 60 wt % of a surfactant.

In another aspect the present invention provides a method of treating a textile, the method comprising the steps of: (i) treating a textile with an aqueous solution of a hydrophobic dye, the aqueous solution comprising from 1 ppb to 5 ppm of the hydrophobic dye, from 1 ppb to 5 ppm of a second dye selected from the group consisting of: hydrolysed reactive dye; acid dye; and direct dye; and, from 0.2 g/L to 3 g/L of a surfactant; and, (ii) rinsing and drying the textile. Most preferably the hydrophobic dye is at a concentration in the range from 10 ppb to 500 ppb. It is preferred that the aqueous solution has an ionic strength from 0.001 to 0.5. The present invention also extends to the aqueous solution used in the method. The method is preferably applied to a textile that has been worn at least one and therefore is soiled.

A “unit dose” as used herein is a particular amount of the laundry treatment composition used for a type of wash, conditioning or requisite treatment step. The unit dose may be in the form of a defined volume of powder, granules or tablet or unit dose detergent liquid.

### DETAILED DESCRIPTION OF THE INVENTION

When a garment is of mixed fibre, i.e., polyester cotton, dyes that are substantive to each respective fibre are required because otherwise even whiteness across the fibre threads is not maintained.

It is preferred that the other dye, as for the hydrophobic dye, has a maximum extinction coefficient greater than 1000 L/mol/cm in the wavelength range of 400 to 750 nm. Tuning of levels of the respective dyes in the composition will be such that dye deposition to the polyester and cotton will be aesthetically matched. It is preferred that the dyes have a peak absorption wavelength of from 550 nm to 650 nm, preferably from 570 nm to 630 nm. A combination of dyes may be used which together have the visual effect on the human eye as a single dye having a peak absorption wavelength on polyester or cotton of from 550 nm to 650 nm, preferably from 570 nm to 630 nm. This may be provided, for example by mixing a red and green-blue dye to yield a blue or violet shade. A specific example for the acid dyes is a mixture of acid red 17 and acid black 1. The same spectral quantities are required for both the cotton and polyester substantive dyes.

Hydrophobic Dye

Hydrophobic dyes are defined as organic compounds with a maximum extinction coefficient greater than 1000 L/mol/cm in the wavelength range of 400 to 750 nm and that are uncharged in aqueous solution at a pH in the range from 7 to 11. The hydrophobic dyes are devoid of polar solubilizing groups. In particular the hydrophobic dye does not contain any sulphonic acid, carboxylic acid, or quaternary ammonium groups. The dye chromophore is preferably selected from the group comprising: azo; anthraquinone; phthalocyanine; and, triphenylmethane chromophores. Most preferred are azo and anthraquinone dye chromophores.

Many examples of hydrophobic dyes are found in the classes of solvent and disperse dyes.

Shading of white garments may be done with any colour depending on consumer preference. Blue and Violet are particularly preferred shades and consequently preferred dyes or mixtures of dyes are ones that give a blue or violet shade on white polyester.

A wide range of suitable solvent and disperse dyes are available. However detailed toxicological studies have shown that a number of such dyes are possible carcinogens, for example disperse blue 1. Such dyes are not preferred. More suitable dyes may be selected from those solvent and disperse dyes used in cosmetics. For example as listed by the European Union in directive 76/768/EEC Annex IV part 1. For example disperse violet 27 and solvent violet 13. It is most preferred that the hydrophobic dye is incorporated into a composition by dissolution in a surfactant slurry or by granulation using non-ionic surfactant to solubilize the dye.

Hydrolysed Reactive Dye (C4400)

The reactive dyes may be considered to be made up of a chromophore which is linked to an anchoring moiety, The chromophore may be linked directly to the anchor or via a bridging group. The chromophore serves to provide a colour and the anchor to bind to a textile substrate.

A marked advantage of reactive dyes over direct dyes is that their chemical structure is much simpler, their absorption bands are narrower and the dyeing/shading are brighter; industrial Dyes, K. Hunger ed. Wiley-VCH 2003 ISBN 3-527-30426-6. However, mammalian contact with reactive dyes results in irritation and/or sensitisation of the respiratory tract and/or skin. In addition, wash conditions are not ideal for deposition of dyes because the efficiency of deposition is low.

With regard to reducing irritation and/or sensitisation, it is preferred that each individual anchor group of each reactive dyes is hydrolysed such that the most reactive group(s) of anchor groups of the dye is/are hydrolysed. In this regard, the term hydrolysed reactive dye encompasses both fully and partially hydrolysed reactive dyes.

The reactive dye may have more than one anchor. If the dye has more than one anchor, then each and every anchor, that contributes to irritation and/or sensitisation, needs to be hydrolysed to the extent discussed above.

The hydrolysed dyes comprise a chromophore and an anchor that are covalently bound and may be represented in the following manner: chromophore-anchor. The linking between the chromophore and an anchor are preferably provided by —NH—CO—, —NH—, NHCO—CH₂CH₂—, —NH—CO—, or —N═N—.

Preferably the hydrolysed reactive dye comprises a chromophore moiety covalently bound to an anchoring group, the anchoring group for binding to cotton, the anchoring group selected from the group consisting of: a heteroaromatic ring, preferably comprising a nitrogen heteroatom, having at least one —OH substituent covalently bound to the heteroaromatic ring, and 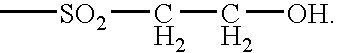
It is preferred that the anchor group is of the form: 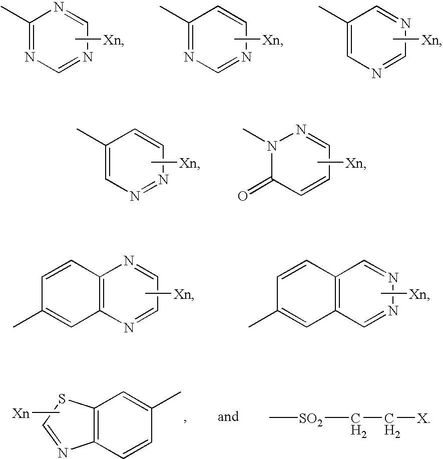
wherein:
n takes a value between 1 and 3;
X is selected from the group consisting of: —Cl, —F, NHR, a quaternary ammonium group, —OR and —OH;
R is selected from: an aromatic group, benzyl, a C1-C6-alkyl; and, wherein at least one X is —OH. It is preferred that R is selected from napthyl, phenyl, and —CH3. Most preferably the anchor group is selected from the group consisting of:

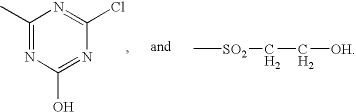

Preferably, the chromophore is selected from the group consisting of: azo, anthraquinone, phthalocyanine, formazan and triphendioaxazine.

Preferably, the chromophore is linked to the hydrolysed anchor by a bridge selected from the group consisting of: —NH—CO—, —NH—, NHCO—CH2CH2-, —NH—CO—, and —N═N—.

Most preferred hydrolysed reactive dyes are hydrolysed Reactive Red 2, hydrolysed Reactive Blue 4, hydrolysed Reactive Black 5, and hydrolysed Reactive Blue 19.

Acid Dye (C4397) (C4389) (C4334) (C4335) (C4308) (C4333)

The following are preferred classes of acid dyes.

The group comprising blue and violet acid dyes of structure 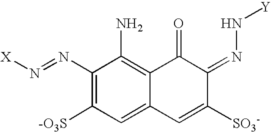
where at least one of X and Y must be an aromatic group, preferably both, the aromatic groups may be a substituted benzyl or napthyl group, which may be substituted with non water solubilising groups such as alkyl or alkyloxy or aryloxy groups, X and Y may not be substituted with water solubilising groups such as sulphonates or carboxylates, most preferred is where X is a nitro substituted benzyl group and Y is a benzyl group.

The group comprising red acid dyes of structure 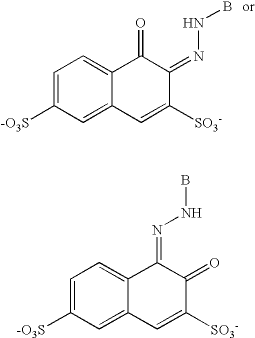
where B is a napthyl or benzyl group that may be substituted with non water solubilising groups such as alkyl or alkyloxy or aryloxy groups, B may not be substituted with water solubilising groups such as sulphonates or carboxylates.

The group the following structures: 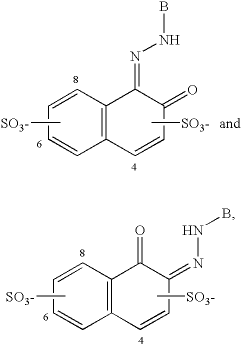
wherein:
the naphthyl is substituted by the two SO₃— groups in one of the following selected orientations about ring: 7,8; 6,8; 5,8; 4,8; 3,8; 7,6; 7,5; 7,4; 7,3; 6,5; 6,4; 5,4; 5,3, and 4, 3;
B is an aryl group selected from phenyl and naphthyl, the aryl group substituted with a group independently selected from: one —NH₂ group; one —NH-Ph group; one —N═N—C6H5; one —N═N—C10H7 group; one or more —OMe; and, one or more -Me. The group of the following structures: 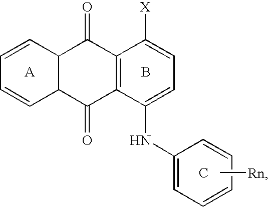
wherein:
X is selected from the group consisting of —OH and —NH2;
R is selected from the group consisting of —CH3 and —OCH3;
n is an integer selected from 0, 12 and 3; and
one of the rings A, B and C is substituted by one sulphonate group.

The following are examples of preferred acid dyes that may be used with the present invention: acid black 24, acid blue 25, acid blue 29, acid black 1, acid blue 113, acid red 17, acid red 51, acid red 73, acid red 88, and acid red 87, acid red 91, acid red 92, acid red 94, and acid violet 17.

Direct Dye (C4307)

The following are examples of direct dyes that may be used with the present invention. Preferably the hydrolysed dye is used in combination with a direct dye.

Preferred direct dyes are selected from the group comprising tris-azo direct blue dyes of the formula: 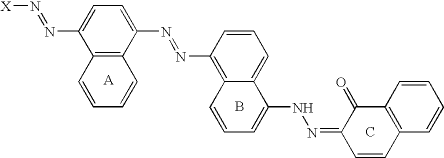
where at least two of the A, B and C napthyl rings are substituted by a sulphonate group, the C ring may be substituted at the 5 position by an NH₂ or NHPh group, X is a benzyl or napthyl ring substituted with upto 2 sulphonate groups and may be substituted at 2 position with a OH group and may also be substituted with an NH₂ or NHPh group,

Most preferred direct dyes are selected from the group comprising bis-azo direct violet dyes of the formula: 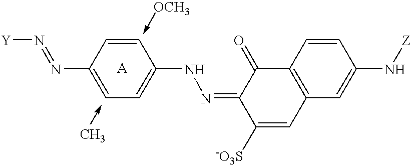
where Z is H or phenyl, the A ring is preferably substituted by a methyl and methoxy group at the positions indicated by arrows, the A ring may also be a naphthyl ring, the Y group is a benzyl or naphthyl ring, which is substituted by sulphate group and may be mono or disubstituted by methyl groups.

Preferred examples of these dyes are direct violet 5, 7, 9, 11, 31, and 51. Further preferred examples of these dyes are also direct blue 34, 70, 71, 72, 75, 78, 82, and 120.

Balance Carriers and Adjunct Ingredients

The laundry treatment composition in addition to the dye comprises the balance carriers and adjunct ingredients to 100 wt % of the composition.

These may be, for example, surfactants, builders, foam agents, anti-foam agents, solvents, fluorescers, bleaching agents, and enzymes. The use and amounts of these components are such that the composition performs depending upon economics, environmental factors and use of the composition.

The composition may comprise a surfactant and optionally other conventional detergent ingredients. The composition may also comprise an enzymatic detergent composition which comprises from 0.1 to 50 wt %, based on the total detergent composition, of one or more surfactants. This surfactant system may in turn comprise 0 to 95 wt % of one or more anionic surfactants and 5 to 100 wt % of one or more nonionic surfactants. The surfactant system may additionally contain amphoteric or zwitterionic detergent compounds, but this in not normally desired owing to their relatively high cost. The enzymatic detergent composition according to the invention will generally be used as a dilution in water of about 0.05 to 2 wt %.

It is preferred that the composition comprises between 2 to 60 wt % of a surfactant, most preferably 10 to 30 wt %. In general, the nonionic and anionic surfactants of the surfactant system may be chosen from the surfactants described “Surface Active Agents” Vol. 1, by Schwartz & Perry, Interscience 1949, Vol. 2 by Schwartz, Perry & Berch, Interscience 1958, in the current edition of “McCutcheon's Emulsifiers and Detergents” published by Manufacturing Confectioners Company or in “Tenside-Taschenbuch”, H. Stache, 2nd Edn., Carl Hauser Verlag, 1981.

Suitable nonionic detergent compounds which may be used include, in particular, the reaction products of compounds having a hydrophobic group and a reactive hydrogen atom, for example, aliphatic alcohols, acids, amides or alkyl phenols with alkylene oxides, especially ethylene oxide either alone or with propylene oxide. Specific nonionic detergent compounds are C₆ to C₂₂ alkyl phenol-ethylene oxide condensates, generally 5 to 25 EO, i.e. 5 to 25 units of ethylene oxide per molecule, and the condensation products of aliphatic C₈ to C₁₈ primary or secondary linear or branched alcohols with ethylene oxide, generally 5 to 40 EO.

Suitable anionic detergent compounds which may be used are usually water-soluble alkali metal salts of organic sulphates and sulphonates having alkyl radicals containing from about 8 to about 22 carbon atoms, the term alkyl being used to include the alkyl portion of higher acyl radicals. Examples of suitable synthetic anionic detergent compounds are sodium and potassium alkyl sulphates, especially those obtained by sulphating higher C₈ to C₁₈ alcohols, produced for example from tallow or coconut oil, sodium and potassium alkyl C₉ to C₂, benzene sulphonates, particularly sodium linear secondary alkyl C₁₀ to C₁₅ benzene sulphonates; and sodium alkyl glyceryl ether sulphates, especially those ethers of the higher alcohols derived from tallow or coconut oil and synthetic alcohols derived from petroleum. The preferred anionic detergent compounds are sodium C₁₁ to C₁₅ alkyl benzene sulphonates and sodium C₁₂ to C₁₈ alkyl sulphates. Also applicable are surfactants such as those described in EP-A-328 177 (Unilever), which show resistance to salting-out, the alkyl polyglycoside surfactants described in EP-A-070 074, and alkyl monoglycosides.

Preferred surfactant systems are mixtures of anionic with nonionic detergent active materials, in particular the groups and examples of anionic and nonionic surfactants pointed out in EP-A-346 995 (Unilever). Especially preferred is surfactant system that is a mixture of an alkali metal salt of a C₁₆ to C₁₈ primary alcohol sulphate together with a C₁₂ to C₁₅ primary alcohol 3 to 7 EO ethoxylate.

The nonionic detergent is preferably present in amounts greater than 10%, e.g. 25 to 90 wt % of the surfactant system. Anionic surfactants can be present for example in amounts in the range from about 5% to about 40 wt % of the surfactant system.

Cationic Compound

When the present invention is used as a fabric conditioner it needs to contain a cationic compound.

Most preferred are quaternary ammonium compounds.

It is advantageous if the quaternary ammonium compound is a quaternary ammonium compound having at least one C₁₂ to C₂₂ alkyl chain.

It is preferred if the quaternary ammonium compound has the following formula:

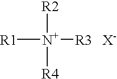

in which R¹ is a C₁₂ to C₂₂ alkyl or alkenyl chain; R², R³ and R⁴ are independently selected from C₁ to C₄ alkyl chains and X⁻ is a compatible anion. A preferred compound of this type is the quaternary ammonium compound cetyl trimethyl quaternary ammonium bromide.

A second class of materials for use with the present invention are the quaternary ammonium of the above structure in which R¹ and R² are independently selected from C₁₂ to C₂₂ alkyl or alkenyl chain; R³ and R⁴ are independently selected from C₁ to C₄ alkyl chains and X⁻ is a compatible anion.

A detergent composition according to claim 1 in which the ratio of (ii) cationic material to (iv) anionic surfactant is at least 2:1.

Other suitable quaternary ammonium compounds are disclosed in EP 0 239 910 (Proctor and Gamble).

It is preferred if the ratio of cationic to nonionic surfactant is from 1:100 to 50:50, more preferably 1:50 to 20:50.

The cationic compound may be present from 0.02 wt % to 20 wt % of the total weight of the composition.

Preferably the cationic compound may be present from 0.05 wt % to 15 wt %, a more preferred composition range is from 0.2 wt % to 5 wt %, and most preferably the composition range is from 0.4 wt % to 2.5 wt % of the total weight of the composition.

If the product is a liquid it is preferred if the level of cationic surfactant is from 0.05 wt % to 10 wt % of the total weight of the composition. Preferably the cationic compound may be present from 0.2 wt % to 5 wt %, and most preferably from 0.4 wt % to 2.5 wt % of the total weight of the composition.

If the product is a solid it is preferred if the level of cationic surfactant is 0.05 wt % to 15 wt % of the total weight of the composition. A more preferred composition range is from 0.2 wt % to 10 wt %, and the most preferred composition range is from 0.9 wt % to 3.0 wt % of the total weight of the composition.

Bleaching Species

The laundry treatment composition may comprise bleaching species. The bleaching species, for example, may selected from perborate and percarbonate. These peroxyl species may be further enhanced by the use of an activator, for example, TAED or SNOBS. Alternatively or in addition to, a transition metal catalyst may used with the peroxyl species. A transition metal catalyst may also be used in the absence of peroxyl species where the bleaching is termed to be via atmospheric oxygen, see, for example WO02/48301. Photobleaches, including singlet oxygen photobleaches, may be used with the laundry treatment composition. A preferred photobleach is vitamin K3.

Fluorescent Agent

The laundry treatment composition most preferably comprises a fluorescent agent (optical brightener). Fluorescent agents are well known and many such fluorescent agents are available commercially. Usually, these fluorescent agents are supplied and used in the form of their alkali metal salts, for example, the sodium salts. The total amount of the fluorescent agent or agents used in laundry treatment composition is generally from 0.005 to 2 wt %, more preferably 0.01 to 0.1 wt %. Preferred classes of fluorescer are: Di-styryl biphenyl compounds, e.g. Tinopal (Trade Mark) CBS-X, Di-amine stilbene di-sulphonic acid compounds, e.g. Tinopal DMS pure Xtra and Blankophor (Trade Mark) HRH, and Pyrazoline compounds, e.g. Blankophor SN. Preferred fluorescers are: sodium 2 (4-styryl-3-sulfophenyl)-2H-napthol[1,2-d]trazole, disodium 4,4′-bis{[(4-anilino-6-(N methyl-N-2 hydroxyethyl)amino 1,3,5-triazin-2-yl)]amino}stilbene-2-2′ disulfonate, disodium 4,4′-bis{[(4-anilino-6-morpholino-1,3,5-triazin-2-yl)]amino}stilbene-2-2′ disulfonate, and disodium 4,4′-bis(2-sulfoslyryl)biphenyl.

### EXAMPLES

### Example 1

Approximately 1000 ppm solutions of the dyes listed in the table below, were made in ethanol.

A stock solution of 1.8 g/L of a base washing powder in water was created. The washing powder contained 18% NaLAS, 73% salts (silicate, sodium tri-poly-phosphate, sulphate, carbonate), 3% minors including perborate, fluorescer and enzymes, remainder impurities and water. The solution was divided into 100 ml aliquots and the solvent dyes added from the ethanol solutions to give approximately 5.8 ppm solutions. 1 g of pure woven polyester fabric was added to each of the wash solutions and the solution then shaken for 30 minutes, rinsed and dried. From the colour of the fabric it was clear that dye had deposited to the fabric. To quantify this the colour was measured using a reflectance spectrometer and expresses as the deltaE value compared to a polyester washed analogously but without dye present.

The results are given below

| | Dye - | |
|---|---|---|
| | ppm in | |
| Dye | solution | deltaE |
| No dye | 0 | 0.2 |
| (to indicate error level) | | |
| 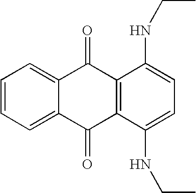 | 5.8 | 0.7 |
| solvent blue 59 | | |
| 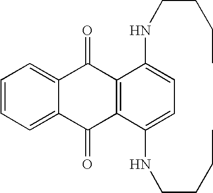 | 5.6 | 2.7 |
| solvent blue 35 | | |
| 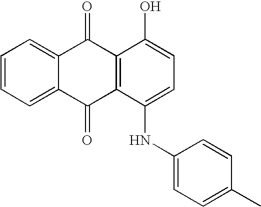 | 5.9 | 2.2 |
| solvent violet 13 | | |
| 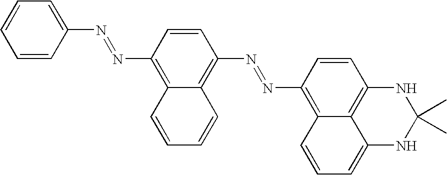 | 5.7 | 5.0 |
| solvent black 3 | | |
| 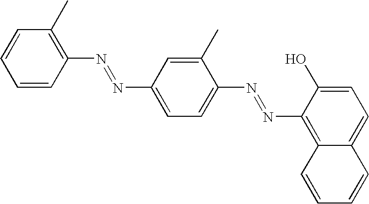 | 5.8 | 10.6 |
| solvent red 24 | | |
| 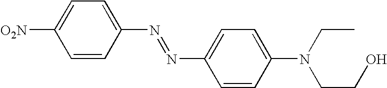 | 5.8 | 10.9 |
| disperse red 1 | | |
| 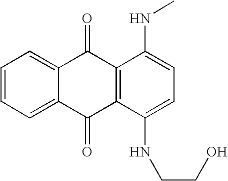 | 5.8 | 4.1 |
| disperse blue 3 | | |
| 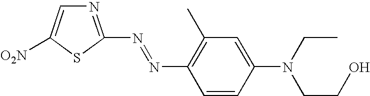 | 5.8 | 4.8 |
| disperse blue 106 | | |

### Example 2

Experiment was repeated using polyester fleece fabric. The solvent dyes, solvent violet 13, solvent black 3, solvent red 24, solvent blue 35 and solvent blue 59 gave deltaE's of 6.2, 9.5, 15.8, 13.5 and 1.8 respectively. Again showing they all deposited to polyester fabric.

### Example 3

To examine the sensitivity of deposition to formulation components the experiment of Example 2 was repeated, except different wash solutions were utilised as outlined below and 4.9 ppm solvent violet 13 used in solution. In all experiments washes were also conducted without dye, the colour of the cloth compared using a reflectometer and expressed as deltaE. The results are shown below.

| Wash conditions | deltaE |
|---|---|
| 0.3 g/L SDS surfactant | 7.0 |
| 0.3 g/L SDS surfactant + 3 g/L | 8.3 |
| NaCl | |
| 0.3 g/L SDS surfactant + 3 g/L | 4.7 |
| NaCl + pH adjusted to 10.5 | |
| using NaOH | |
| 0.3 g/L SDS surfactant + 3 g/L | 4.2 |
| NaCl + 0.5 g/L 7EO nonionic | |
| surfactant | |
| 1.6 g/L surfactant | 5.5 |

Dye was deposited to the polyester in all cases.

### Example 4

The experiments of Example 1 was repeated using different levels of solvent violet 13 and solvent black 3 and a wash time of 45 minutes. The results are shown below. The shading effect expresses as deltaE builds up approximately linearly with amount of dye in this range.

| Dye | deltaE |
|---|---|
| No dye | 0.2 |
| 0.5 ppm solvent violet 13 | 0.5 |
| 2.0 ppm solvent violet 13 | 1.3 |
| 4.0 ppm solvent violet 13 | 3.3 |
| 0.9 ppm solvent black 3 | 1.0 |
| 1.9 ppm solvent black 3 | 2.0 |

### Example 5

The experiments of Example 1 was repeated except 2.5 ppm solvent violet 13 was used and a liquor to cloth ratio of 30:1. After the wash the cloth was dried and the deltaE measured compared to cloth washed without dye. The process was the repeated 5 more times and the results shown below. The shading effect shading effect expresses as deltaE builds up approximately linearly with washes in this range.

| Wash number | deltaE |
|---|---|
| 1 | 0.7 |
| 2 | 1.5 |
| 3 | 1.9 |
| 4 | 2.1 |
| 5 | 2.5 |
| 6 | 3.1 |

This experiment in combination with Example 4 shows that very low levels of solvent violet 13 could be used in formulations and the shading effect allowed to build over a number of washed (5-40).

### Example 6

The experiment of Example 1 was repeated except using a different selection and combination of dyes as shown in the table below. The cloth used was 1.4 g of woven 50:50 polyester:cotton, washed in 100 ml solution for 30 minutes. Polyester substantive and cotton substantive dyes may be used together to give bigger benefits.

Ppm dye

| Solvent violet | Direct Violet | |
|---|---|---|
| 13 | 51 | deltaE |
| 0 | 0 | 0.1 |
| 1 | 0 | 1.1 |
| 1 | 0.06 | 2.9 |
| 0 | 0.06 | 2.0 |

1. A laundry treatment composition comprising:
Between 0.0001 to 0.1 wt % of a hydrophobic dye for shading polyester;
Between 0.0001 to 0.1 wt % of one or more other dyes selected from cotton substantive shading dyes of the group consisting of: hydrolysed reactive dye; acid dye; and direct dye; and, between 2 to 60 wt % of a surfactant,
Wherein the acid dye is selected from a group consisting of: blue and violet acid dyes of structure 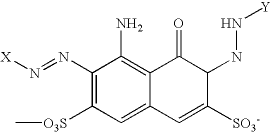
Where at least one of X and Y must be an aromatic group, preferably both, the aromatic groups may be a substituted benzyl or napthyl group, which may be substituted with non water solubilising groups such as alkyl or alkyloxy or aryloxy groups, X and Y may not be substituted with water solubilising groups such as sulphonates or carboxylates, most preferred is where X is a nitro substituted benzyl group and Y is a benzyl group;
Red acid dyes of structure: 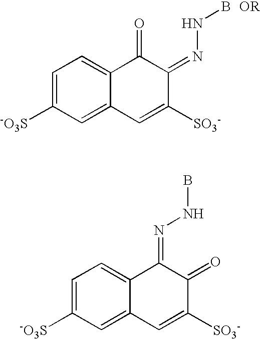
Where B is a napthyl or benzyl group that may be substituted with non water solubilising groups such as alkyl or alkyloxy or aryloxy groups, B may not be substituted with water solubilising groups such as sulphonates or carboxylates;
Acid dyes the following structure: 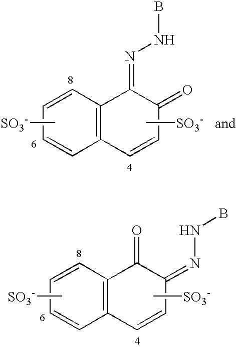
Wherein:
The naphthyl is substituted by the two SO₃— groups in one of the following selected orientations about ring: 7,8; 6,8; 5,8; 4,8; 3,8; 7,6; 7,5; 7,4; 7,3; 6,5; 6,4; 5,4; 5,3; and 4,3;
B is an aryl group selected from phenyl and naphthyl, the aryl group substituted with a group independently selected from: one —NH2 GROUP; one —NH-Ph group; one —N═N—C6H5; one —N═N—ClOH7 group; one or more —OM3; and, one or more -Me;
Acid dyes of the following structures: 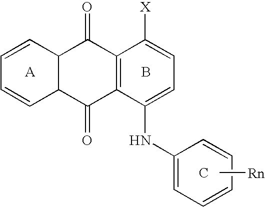
Wherein:
X is selected from the group consisting of —OH and —NH2;
R is selected from the group consisting of —CH3 and —OCH3;
n is an integer selected from 0, 12 and 3; and
one of the rings A, B and C is substituted by one sulphonate group; and
wherein the direct dye is selected from the group consisting of: tris-azo direct blue dyes of the formula: 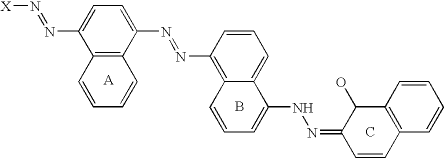
Where at least two of the A, B and C napthyl rings are substituted by a suiphonate group, the C ring may be substituted at the 5 position group, the C ring may be substituted at the 5 position by an NH₂ or NHPh group, X is a benzyl or napthyl ring substituted with up to 2 sulphonate groups and may be substituted at 2 position with a OH group and may also be substituted with an NH₂ or NHPh group; and
Bis-azo direct violet dyes of the formula: 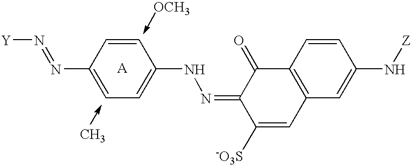
Where Z is H or phenyl, the A ring is optionally substituted by a methyl and methoxy group at the positions indicated by arrows, the A ring may also be a naphthyl ring, the Y group is a benzyl or naphthyl ring, which is substituted by sulphate group and may be mono or disubstituted by methyl groups.

2. A laundry treatment composition according to claim 1, wherein the hydrophobic dye is an organic compounds with a maximum extinction coefficient greater than 1000 L/mol/cm in the wavelength range from 400 to 750 nm and uncharged in an aqueous solution having a pH in the range 7 to 11.

3. A laundry treatment composition according to claim 2, wherein the hydrophobic dye has a maximum extinction coefficient in the wavelength range from 550 to 650 nm.

4. A laundry treatment according to claim 1, wherein respective dyes individually substantive to cotton and polyester have respective peak absorption wavelength on cotton and polyester of from 550 nm to 650 nm.

5. A laundry treatment according to claim 4, wherein the dye comprises a combination of dyes which together have the visual effect on the human eye as a single dye having a peak absorption wavelength on polyester and cotton of from 570 nm to 630 nm.

6. A laundry treatment composition according to claim 1, wherein the chromophore of the hydrophobic dye is selected from the group consisting of: azo; and, anthraquinone, and the chromophore of the hydrolysed reactive dye is selected from the group consisting of: azo, anthraquinone, phthalocyanine, formazan and triphendioaxazine.

7. A laundry treatment composition according to claim 1, wherein the hydrophobic dye is selected from: disperse blue 79, solvent black 3, solvent violet 13, solvent blue 59, solvent blue 35, solvent red 24, disperse red 1, disperse blue 3, and disperse blue 106.

8. A laundry treatment composition according to claim 1, wherein the laundry treatment composition comprises from 0.005 to 2 wt % of a fluorescer.

9. A method of treating a textile, the method comprising the steps of:
(i) treating a textile with an aqueous solution of a hydrophobic dye, the aqueous solution comprising from 10 ppb to 1 ppm of the hydrophobic dye, from 10 ppb to 1 ppm of a second dye selected from the group consisting of: hydrolysed reactive dye; acid dye as defined in claim 1; and direct dye as defined in claim 1; and, from 0.2 g/L to 3 g/L of a surfactant; and,
(ii) rinsing and drying the textile.

10. A method of treating a textile according to claim 9, wherein the aqueous solution has an ionic strength from 0.001 to 0.5.
